(19) United States
(12) Patent Application Publication
(10) Pub. No.: US 2021/0034002 A1
(43) Pub. Date: Feb. 4, 2021

(54) IMAGE FORMING APPARATUS AND STORAGE MEDIUM

(71) Applicant: Konica Minolta, Inc., Tokyo (JP)

(72) Inventors: Shota IGO, Toyokawa-shi (JP); Keigo OGURA, Tokyo (JP); Naoto SUGAYA, Tokyo (JP); Hiroshi YAMAGUCHI, Toyokawa-shi (JP)

(21) Appl. No.: 16/942,901

(22) Filed: Jul. 30, 2020

(30) Foreign Application Priority Data
Aug. 2, 2019 (JP) 2019-142630

(51) Int. Cl. G03G 15/00; B65H 5/06; B65H 7/02

(52) U.S. Cl. CPC G03G 15/5008; B65H 7/02; B65H 5/062; G03G 15/6529

(57) ABSTRACT

An image forming apparatus includes the following, a pair of first conveying rollers, a pair of second conveying rollers, a driver which rotates and drives the second conveying rollers by a command value; and a controller which is able to control the driver to perform constant speed control to rotate the pair of second conveying rollers at a constant speed and to perform constant torque control to rotate the pair of second conveying rollers at a constant torque. When the constant torque control is performed, the controller starts the constant torque control with a predetermined initial torque. Based on sheet interval torque detected in a sheet interval term in which the pair of second conveying rollers do not sandwich and convey a sheet after the first sheet reaches the pair of second conveying rollers, the controller corrects the initial torque and calculates a command value for the next sheet.

### CROSS-REFERENCE TO RELATED APPLICATIONS

The present invention claims priority under 35 U.S.C. § 119 to Japanese Application No. 2019-142630 filed on Aug. 2, 2019, the entire content of which is incorporated herein by reference.

### BACKGROUND

### Technological Field

The present invention relates to an image forming apparatus and a storage medium.

### Description of the Related Art

Conventionally, there is an image forming apparatus which uses an electronic photography method. In such image forming apparatus, an electrostatic latent image formed on a photoconductor is developed with toner to form a toner image, the formed toner image is transferred on a sheet with the transfer roller, and the transferred toner image is held and conveyed with the fixing roller to be heated and fixed. With this, the image is formed on the sheet.

In such image forming apparatus, sheet loop reaction force is generated by the difference in conveying speed between a transfer roller and a fixing roller, and this may cause problems in an image such as displacement of color or shock noise. The influence is large especially in sheets with high rigidity, and this becomes an obstacle when the usable sheet type is increased.

In order to cope with the above problems, there is a configuration which weakens the power of pressure of the transfer unit, but image position accuracy worsens in such configuration.

For example, JP 2018-045017 describes in order to lose the circumferential speed difference from the transfer roller to the fixing roller, the speed of the fixing motor is not controlled to be fixed to the output torque of the average load torque of the fixing roller so that the sheet conveying speed of the fixing roller is similar to the conveying speed of transfer.

In the control described in JP 2018-045017, when the sheet is conveyed successively, the circumferential speed changes due to the change in the conveying speed caused by thermal expansion of the fixing roller and the change in the load in the driven motor due to the pressured state of the fixing roller. Therefore, the suitable output torque setting is necessary for the heat expansion state of the fixing roller.

However, if the torque is measured between the sheets, it is difficult to secure a sufficient amount of time. Further, since there is a load torque change in the fixing roller cycle, the torque may be shifted if the phase of the load torque change is not obtained. Therefore, if the sampling of the load torque fails, there may be an error in the output torque setting.

### SUMMARY

It is an object of the present invention to perform suitable output torque setting and to suppress damage to quality due to a difference in conveying speeds between two rollers.

To achieve at least one of the abovementioned objects, according to an aspect of the present invention, an image forming apparatus reflecting one aspect of the present invention includes a pair of first conveying rollers which successively convey a sheet and a pair of second conveying rollers which are provided on a downstream side of a conveying direction of the pair of first conveying rollers; a driver which rotates and drives the pair of second conveying rollers by a command value; and a controller which is able to control the driver to perform constant speed control to rotate the pair of second conveying rollers at a constant speed and to perform constant torque control to rotate the pair of second conveying rollers at a constant torque, wherein, when the constant torque control is performed, the controller starts the constant torque control with a predetermined initial torque, and based on sheet interval torque detected in a sheet interval term in which the pair of second conveying rollers do not sandwich and convey a sheet after the first sheet reaches the pair of second conveying rollers, the controller corrects the initial torque and calculates a command value for the next sheet.

According to another aspect of the present invention, a non-transitory computer-readable storage medium storing a program for a computer of an image forming apparatus including a pair of first conveying rollers which successively convey a sheet and a pair of second conveying rollers which are provided on a downstream side of a conveying direction of the pair of first conveying rollers; and a driver which rotates and drives the pair of second conveying rollers by a command value; the program causing the computer to function as: a controller which is able to control the driver to perform constant speed control to rotate the pair of second conveying rollers at a constant speed and to perform constant torque control to rotate the pair of second conveying rollers at a constant torque, wherein, when the constant torque control is performed, the controller starts the constant torque control with a predetermined initial torque, and based on sheet interval torque detected in a sheet interval term in which the pair of second conveying rollers do not sandwich and convey a sheet after the first sheet reaches the pair of second conveying rollers, the controller corrects the initial torque and calculates a command value for the next sheet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram showing a schematic configuration of an image forming apparatus according to an embodiment of the present invention,

FIG. 2 is a block diagram showing a configuration of a main function in the image forming apparatus,

FIG. 3 is a diagram showing a configuration of an image former and an image fixer,

FIG. 4 is a flowchart showing control of the image forming apparatus,

FIG. 5 is a diagram showing a change in speed of a fixing roller, and

FIG. 6 is a diagram enlarging part of FIG. 5.

### DETAILED DESCRIPTION OF THE EMBODIMENTS

Hereinafter, embodiments of the image forming apparatus according to the present invention are described with reference to the drawings. A color image forming apparatus is described in the embodiments of the present invention, but the present invention is not limited to such image forming apparatus. For example, the present invention can be applied to a black and white image forming apparatus.

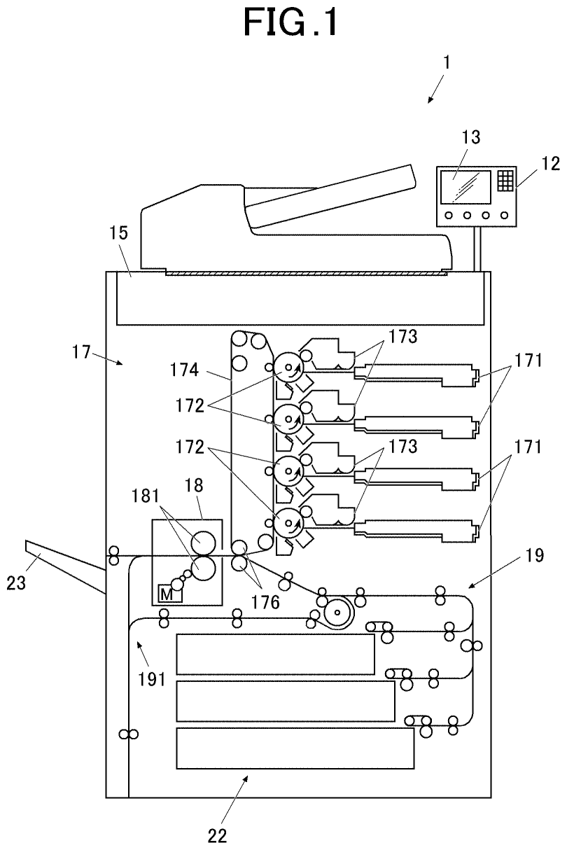

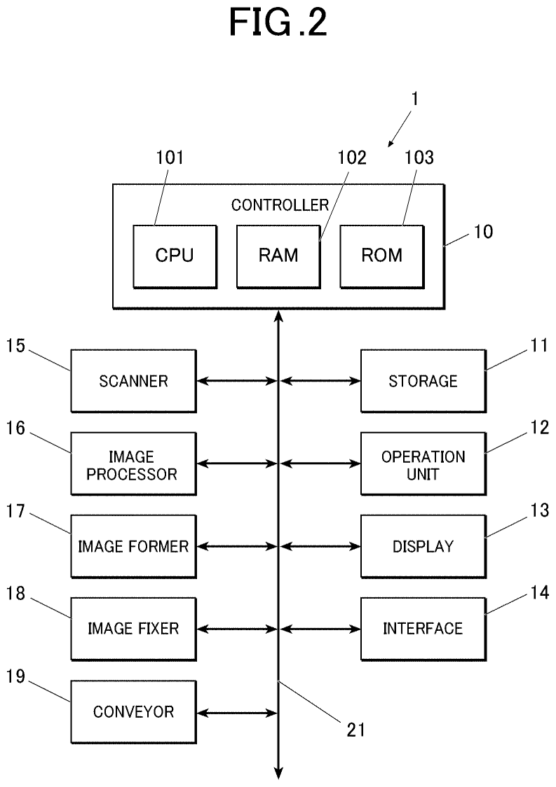

FIG. 1 is a diagram showing a schematic configuration of the image forming apparatus 1 according to an embodiment of the present invention. FIG. 2 is a block diagram showing a configuration of the main functions in the image forming apparatus 1.

The image forming apparatus 1 includes a controller 10 which includes a CPU 101 (Central Processing Unit), a RAM 102 (Random Access Memory), and a ROM 103 (Read Only Memory), a storage 11, an operation unit 12, a display 13, an interface 14, a scanner 15, an image processor 16, an image former 17, an image fixer 18, and a conveyor 19.

The controller 10 is connected to a storage 11, an operation unit 12, a display 13, an interface 14, a scanner 15, an image processor 16, an image former 17, an image fixer 18, and a conveyor 19 through a bus 21.

The CPU 101 retrieves a program for control stored in the ROM 103 or the storage 11 and performs various calculating processing.

The RAM 102 provides a memory space for work to the CPU 101 to store temporary data.

The ROM 103 stores various control programs executed in the CPU 101 and setting data.

Instead of the ROM 103, a rewritable nonvolatile memory such as an EEPROM (Electrically Erasable Programmable Read Only Memory) or a flash memory can be used.

The controller 10 which includes the CPU 101, the RAM 102, and the ROM 103 centrally controls each unit of the image forming apparatus 1 according to the above various control programs. For example, the controller 10 controls the image processor 16 to perform a predetermined image processing on the image data and stores the processed data in the storage 11. The controller 10 controls the conveyor 19 to convey the sheet S, and controls the image former 17 to form the image on the sheet S based on the image data stored in the storage 11.

The storage 11 includes a semiconductor memory such as a DRAM (Dynamic Random Access Memory), a HDD (Hard Disk Drive), etc., and image data obtained by the scanner 15, image data input from outside through the interface 14, etc. are stored. Such image data, etc. can be stored in the RAM 102.

The operation unit 12 includes an input device such as an operation key or a touch panel provided overlapped on the screen of the display 13. The operation unit 12 converts the input operation on the input device to an operation signal and outputs the signal to the controller 10.

The display 13 includes a display apparatus such as a LCD (Liquid Crystal Display) and displays the state of the image forming apparatus 1 or the operation screen showing the contents of the input operation on the touch panel.

The interface 14 transmits and receives data between external computers and other image forming apparatuses, and for example, includes any of various serial interfaces.

The scanner 15 reads the image formed on the sheet S, generates the image data including the single color image data for each color component including R (red), G (green), and B (blue), and stores the image data in the storage 11.

For example, the image processor 16 includes, for example, a rasterizing processor, a color convertor, a gradation corrector, and a halftone processor, and various image processing is performed on the image data stored in the storage 11 and the processed image data is stored in the storage 11.

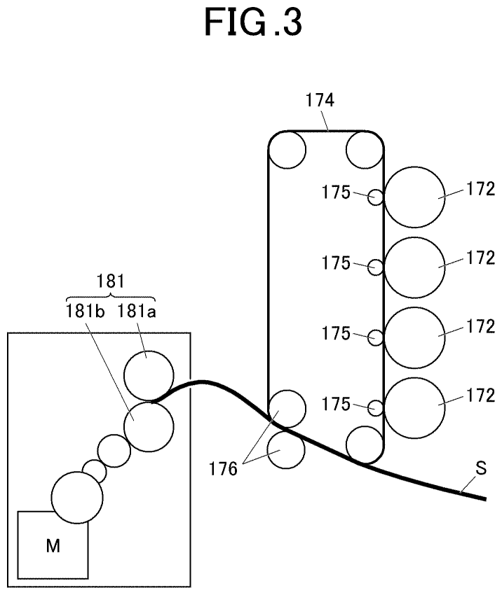

FIG. 3 is a schematic diagram showing a configuration of the image former 17 and the image fixer 18.

As shown in FIG. 1 and FIG. 3, the image former 17 forms an image on the sheet S based on the image data stored in the storage 11. The image former 17 includes four sets of the following, an exposer 171, a photoconductor drum 172, and a developer 173. Each set corresponds to each color component including C (cyan), M (magenta), Y (yellow), and K (black). The image former 17 includes an intermediate transfer body 174, a primary transfer roller 175, and a secondary transfer roller 176.

The exposer 171 includes a LD (Laser Diode) as a light emitting element. The exposer 171 drives the LD based on the image data, emits laser light on the charged photoconductor drum 172 to be exposed, and forms the electrostatic latent image on the photoconductor drum 172. The developer 173 supplies toner (color material) of a predetermined color (any of C, M, Y or K) on the exposed photoconductor drum 172 with the charged developing roller and develops the electrostatic latent image formed on the photoconductor drum 172.

The images (single color image) formed with the toner in each color of C, M, Y, and K on the four photoconductor drums 172 each corresponding to C, M, Y, and K are sequentially transferred from each photoconductor drum 172 to the intermediate transfer body 174 and overlapped.

The intermediate transfer body 174 is a semi-conductive endless belt which hangs on a plurality of rollers and which is supported to be rotatable. The intermediate transfer body 174 is driven to rotate with the rotation of the roller. The intermediate transfer body 174 rotates according to the rotation of the transfer conveying roller when the toner image is transferred.

The intermediate transfer body 174 is pressed against each photoconductor drum 172 by the primary transfer roller positioned opposite to each photoconductor drum 172. The transfer current passes the primary transfer roller 175 according to the applied voltage. With this, the toner images developed on the surface of the photoconductor drums 172 are transferred sequentially on the intermediate transfer body 174 by the primary transfer rollers 175 (primary transfer).

The secondary transfer roller 176 is pressed by the intermediate transfer body 174 and follows the rotation of the intermediate transfer body 174. With this, the toner images in each color of YMCK which are transferred and formed on the intermediate transfer body 174 are transferred on the sheet S conveyed from the sheet feeder (secondary transfer). The sheet S passes between a transfer nip formed between the secondary transfer rollers 176 and the toner image on the intermediate transfer body 174 is transferred on the sheet S as the secondary transfer. The residual toner on the intermediate transfer body 174 is removed by the cleaner which is not shown.

The image fixer 18 performs a fixing process in which the sheet S on which the toner is transferred is heated and pressured to fix the toner on the sheet S. As shown in FIG. 3, the image fixer 18 includes fixing rollers 181, and the fixing roller 181 includes a heating roller 181a and a pressuring roller 181b.

The heating roller 181a includes a halogen lamp heater (not shown) extending in a rotating axis direction inside the heating roller 181a. The halogen lamp heater emits heat by current carried under the control of the controller 10. A fixing belt (not shown) is hung on the outer circumference of the heating roller 181a. The heating roller 181a with the fixing belt is included in a fixing nip which holds and conveys the sheet S in between the heating roller 181a and the pressuring roller 181b.

The pressuring roller 181b is biased in a direction to become close to the heating roller 181a by an elastic member (not shown). The pressuring roller 181b is pressed to the heating roller 181a with the fixing belt in between and the pressuring roller 181b and the heating roller 181a form the fixing nip. The pressuring roller 181b is driven and rotated by the rotating driving power of the fixing motor M under the control of the controller 10.

For example, the fixing motor M is a brushless motor and functions as a driving unit which drives the pressuring roller 181b.

The fixing motor M is provided with a measuring unit which measures the output torque of the fixing motor M.

The fixing roller 181 sandwiches the sheet S with the fixing nip and heats and pressures the sheet S while conveying the sheet S in a predetermined conveying direction. With this, the fixing roller 181 melts the toner on the sheet S and fixes the toner. The temperature of the fixing belt when in contact with the sheet S is to be in a range of 180° C. or more and 200° C. or less. Therefore, the controller 10 controls the halogen lamp heater so that through the influence of the heating roller 181a, the fixing belt is within this temperature range.

As shown in FIG. 1, the conveyor 19 is provided with a plurality of sheet conveying rollers which rotate in a state with the sheet S in between to convey the sheet S, and the sheet S is conveyed on a predetermined conveying path. The conveyor 19 is also provided with an inverting mechanism 191 which reverses the front and back of the sheet S on which the fixing process is performed by the image fixer 18 and which conveys the sheet to the secondary transfer roller 176. When the image is formed on both sides of the sheet S in the image forming apparatus 1, after the front and back of the sheet S is reversed by the inverting mechanism 191 and the image is formed on both sides of the sheet S, the sheet S is ejected from the sheet ejection tray 23. When the image is formed on only one side of the sheet S, the front and back of the sheet S is not reversed by the inverting mechanism 191, and the sheet S on which the image is formed on one side is ejected from the sheet ejection tray 23.

Next, sheet reaction force which occurs between the image former 17 and the image fixer 18 is described.

The sheet S which reaches the image former 17 is then sandwiched and conveyed by the secondary transfer rollers 176 and the fixing rollers 181. Here, the transfer and fixing is completed through the following states, sandwiched only by the secondary transfer rollers 176, sandwiched by both the secondary transfer rollers 176 and the fixing rollers 181, and sandwiched by only the fixing rollers 181.

When sandwiched by either the secondary rollers 176 or the fixing rollers 181, the conveying speed of the sheet S follows the circumferential speed of the secondary transfer roller 176 (transfer conveying speed) or the circumferential speed of the fixing roller 181 (fixing conveying speed).

On the other hand, when the sheet S is sandwiched by both the secondary transfer rollers 176 and the fixing rollers 181, the sheet S is influenced by both of the above. If the circumferential speed of the above two is different, for example, if fixing conveying speed is slower than transfer conveying speed, the sheet S forms a loop between the two rollers. The reaction force of the sheet caused by the above provides a load on the intermediate transfer body 174 and causes damage to the image.

In order to suppress such damage to the quality, there is a necessity to set the transfer conveying speed and the fixing conveying speed to the same speed when the sheet S is sandwiched by both the secondary transfer rollers 176 and the fixing rollers 181.

Next, the control of the image forming apparatus 1 is described.

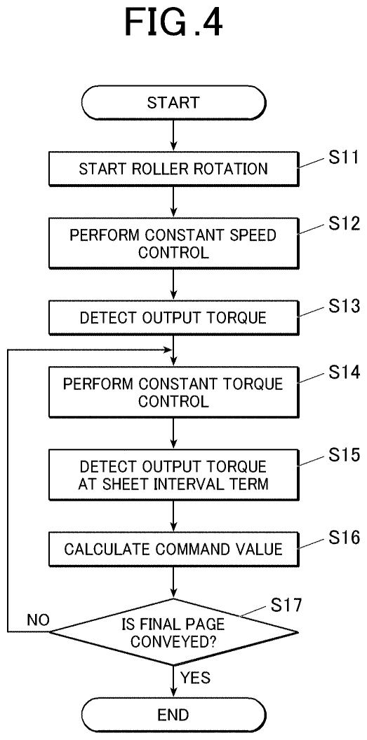

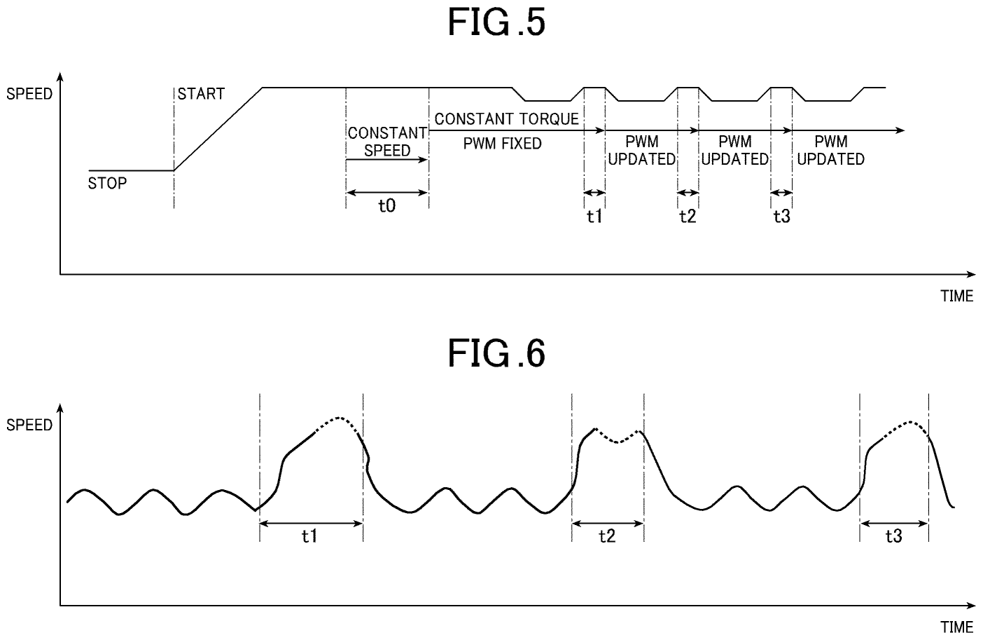

FIG. 4 is a flowchart showing the control performed in the image forming apparatus 1. FIG. 5 is a diagram showing the change in speed of the fixing roller 181, and FIG. 6 is a diagram enlarging a portion of FIG. 5.

As shown in FIG. 4, based on the instruction to execute the image forming process, the controller 10 starts the rotation of the fixing rollers 181 and the secondary transfer rollers 176 (step S11).

Here, the image forming process is a process in which the image is formed on a plurality of sheets S which are conveyed successively.

Next, before the first sheet S after starting the image forming reaches the fixing rollers 181, that is, in the state in which the fixing rollers 181 are not sandwiching and conveying the sheet S, the controller 10 performs constant speed control in which the fixing motor M is controlled to drive the fixing rollers 181 at a constant speed for a predetermined term (t0) (step S12). The controller 10 detects the output torque of the fixing motor M during this term (step S13).

Next, the detected output torque is set to be initial torque, and the controller 10 starts constant torque control to rotate and drive at the initial torque (step S14).

With this, the PWM becomes constant and control is performed so that voltage is always supplied at a certain cycle. In this state, the sheet S is conveyed successively in order from the first sheet S.

Next, the controller 10 detects the output torque in the term from when the first sheet S leaves the fixing rollers 181 to when the second sheet S reaches the fixing rollers 181, that is, a sheet interval term (t1) between the successively conveyed sheets S (step S15).

Next, based on the detected output torque (sheet interval torque), the controller 10 corrects the initial torque, calculates a command value and outputs the value to the fixing motor M (step S16).

Here, as the sheet interval torque, the controller 10 detects output torque for the term corresponding to a length in an integer multiple of the circumferential length of the fixing roller 181.

If the output torque detected in one sheet interval term is not effective information, the controller 10 detects output torque in a plurality of sheet interval terms (t1, t2, t3, etc.), calculates an average value, and obtains the sheet interval torque.

As shown in FIG. 6, it is preferable to use the output torque in the region in which the speed is stable in the sheet interval terms (broken line in FIG. 6).

The controller 10 corrects the initial torque from the difference between the initial torque and the sheet interval torque and calculates the command value.

With this, the PWM is updated.

Next, the controller 10 determines whether the final page is conveyed (step S17). When it is determined that the final page is conveyed (step S17; Yes), the process ends. When it is determined that the final page is not conveyed (step S17; No), the process moves on to step S14.

In step S15, the controller 10 may calculate the rotation phase of the fixing roller 181 which can be measured in the sheet interval term from the detected sheet interval torque and control the rotation phase of the fixing roller 181 to be a predetermined phase in the sheet interval term which follows based on the calculated rotation phase. With this, the torque (efficiency information) corresponding to one cycle of the fixing roller 181 can be efficiently obtained.

In the above step S15, the controller 10 is able to control the timewise length of the sheet interval term. For example, the rotating speed of the fixing roller 181 can be changed in the sheet interval term and the sheet interval term can be controlled so that the timewise length is a predetermined length. With this, it is possible to obtain sheet interval torque (efficiency information) in an arbitrary number of sheet interval terms.

As described above, according to the present embodiment, when constant torque control is performed, the controller 10 starts constant torque control in the predetermined initial torque, and based on the sheet interval torque detected in the sheet interval term in which the sheet is not sandwiched and conveyed by the fixing roller 181 after the first sheet reaches the fixing roller 181, the initial torque is corrected and the command value is calculated.

When the output torque is detected by one sheet interval term, this output torque is to be the sheet interval torque, and when the output torque is detected in a plurality of sheet interval terms, the average value is to be the sheet interval torque.

Therefore, by understanding the change in the torque due to the change in the load of the fixing roller 181, and sampling the output torque, even if a sufficient interval between sheets cannot be secured while conveying the sheets successively, the setting of the suitable output torque can be continued without decreasing productivity.

Therefore, suitable output torque can be set and the damage to the quality due to the difference in the conveying speed between two rollers can be suppressed.

According to the present embodiment, when the process to successively convey sheets starts, the controller 10 performs constant speed control before the first sheet reaches the fixing roller 181, and the output torque detected here is to be the initial torque.

Therefore, the initial torque is obtained before the image forming starts on the first sheet and the constant torque control is performed using the initial torque.

According to the present embodiment, the controller 10 corrects the initial torque from the difference between the initial torque and the sheet interval torque.

Therefore, the amount of the shift from the initial torque can be corrected.

According to the present embodiment, after the process to successively convey the sheet starts, the constant speed control is performed before the first sheet reaches the fixing roller 181 and the initial torque is detected. Alternatively, the constant speed control can be omitted and the constant torque control can be performed using the initial torque set in advance.

The higher the rigidity of the sheet is, the loop reaction force of the sheet due to the difference between the conveying speeds of the secondary transfer roller 176 and the fixing roller 181 tends to occur. That is, the lower the rigidity of the sheet is, the problems due to the sheet loop reaction force hardly occur.

Therefore, whether to perform constant torque control can be determined based on sheet information. Specifically, the controller 10 refers to sheet rigidity as sheet information. When the sheet rigidity is a predetermined value or more, the constant torque control is performed. When the sheet rigidity is less than the predetermined value, the constant speed control of both the secondary transfer roller 176 and the fixing roller 181 is performed.

According to the present embodiment, the secondary transfer roller 176 and the fixing roller 181 are described as the first conveying roller and the second conveying roller, but the combination is not limited to the above two rollers.

Specific details such as configuration, structure, content of control and order of control shown in the above described embodiments can be suitably modified without leaving the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a pair of first conveying rollers which successively convey a sheet and a pair of second conveying rollers which are provided on a downstream side of a conveying direction of the pair of first conveying rollers;
a driver which rotates and drives the pair of second conveying rollers by a command value; and
a controller which is able to control the driver to perform constant speed control to rotate the pair of second conveying rollers at a constant speed and to perform constant torque control to rotate the pair of second conveying rollers at a constant torque,
wherein,
when the constant torque control is performed, the controller starts the constant torque control with a predetermined initial torque, and
based on sheet interval torque detected in a sheet interval term in which the pair of second conveying rollers do not sandwich and convey a sheet after the first sheet reaches the pair of second conveying rollers, the controller corrects the initial torque and calculates a command value for the next sheet.

2. The image forming apparatus according to claim 1, wherein after starting a process in which sheets are successively conveyed, the controller performs the constant speed control before the first sheet reaches the pair of second conveying rollers and output torque detected when the constant speed control is performed is to be the initial torque.

3. The image forming apparatus according to claim 1, wherein,
the pair of first conveying rollers are a pair of transfer rollers which form a toner image on the sheet, and
the pair of second conveying rollers are a pair of fixing rollers which heat and fix the toner image formed on the sheet.

4. The image forming apparatus according to claim 1, wherein, the controller sets an average value of the output torque detected in a plurality of sheet interval terms to be the sheet interval torque.

5. The image forming apparatus according to claim 1, wherein the controller corrects the initial torque from a difference between the initial torque and the sheet interval torque.

6. The image forming apparatus according to claim 1, wherein the controller calculates a rotation phase of the pair of second conveying rollers which can be detected in the sheet interval term with the sheet interval torque, and based on the calculated rotation phase, the controller controls a rotation phase of the pair of second conveying rollers to be a predetermined phase in the following sheet interval term.

7. The image forming apparatus according to claim 1, wherein the controller detects output torque for a term corresponding to an integer multiple of a circumferential length of the pair of second conveying rollers as the sheet interval torque.

8. The image forming apparatus according to claim 1, wherein the controller is able to control a timewise length of the sheet interval term.

9. The image forming apparatus according to claim 1, wherein the controller determines whether to perform the constant torque control based on the sheet information.

10. A non-transitory computer-readable storage medium storing a program for a computer of an image forming apparatus including a pair of first conveying rollers which successively convey a sheet and a pair of second conveying rollers which are provided on a downstream side of a conveying direction of the pair of first conveying rollers; and a driver which rotates and drives the pair of second conveying rollers by a command value; the program causing the computer to function as:
a controller which is able to control the driver to perform constant speed control to rotate the pair of second conveying rollers at a constant speed and to perform constant torque control to rotate the pair of second conveying rollers at a constant torque,
wherein,
when the constant torque control is performed, the controller starts the constant torque control with a predetermined initial torque, and
based on sheet interval torque detected in a sheet interval term in which the pair of second conveying rollers do not sandwich and convey a sheet after the first sheet reaches the pair of second conveying rollers, the controller corrects the initial torque and calculates a command value for the next sheet.
